(19) United States
(12) Patent Application Publication
(10) Pub. No.: US 2025/0321784 A1
(43) Pub. Date: Oct. 16, 2025

(54) TASK EXECUTION METHOD AND SYSTEM, ELECTRONIC DEVICE, AND COMPUTER STORAGE MEDIUM

(71) Applicant: ALIBABA (CHINA) CO., LTD., ZHEJIANG PROVINCE (CN)

(72) Inventors: DAPENG LIU, BEIJING (CN); FEIWEI LEI, BEIJING (CN); JINGYU YANG, BEIJING (CN); HONGRU ZHU, BEIJING (CN)

(21) Appl. No.: 18/688,307

(22) PCT Filed: Aug. 15, 2022
(86) PCT No.: PCT/CN2022/112463

§ 371 Date: Sep. 3, 2024

(30) Foreign Application Priority Data
Aug. 30, 2021 (CN) 202111006428.3

(51) Int. Cl. G06F 9/48; G06F 16/953

(52) U.S. Cl. CPC G06F 9/4881; G06F 16/953

(57) ABSTRACT

Embodiments of the present application provide a task execution method and system, an electronic device, and a computer storage medium. A task execution method comprises: during the process of executing a program code by means of a code execution environment, detecting an execution trigger code for a preset task; according to the execution trigger code, performing scheduling strategy querying by means of the code execution environment to obtain a scheduling strategy for the preset task; and scheduling, via an environment communication interface of the code execution environment, the preset task to be executed in a code execution environment of a cloud target device indicated by the obtained scheduling strategy. By means of embodiments of the present application, the execution speed and efficiency of the preset task are improved, and the running speed of the client terminal is also improved, thereby optimizing the performance of the client terminal.

### CROSS-REFERENCE TO RELATED APPLICATIONS

This application claims priority of Chinese patent applications entitled “TASK EXECUTION METHOD AND SYSTEM, ELECTRONIC DEVICE, AND COMPUTER STORAGE MEDIUM” filed on Aug. 30, 2021 (application No. 202111006428.3); the entire contents of which are incorporated by reference in this application.

### TECHNICAL FIELD

The present application relates to the technical field of internet, and particularly to a task execution method, system, electronic device and computer storage medium.

### BACKGROUND

With the advancement of the internet technology, various applications such as live streaming applications, short video applications, and artificial intelligence (AI)-based applications have increasingly high performance requirements for data processing, transmission latency, throughput rate, and computing power, and the conventional approach which relies solely on the terminal device for processing is no longer sufficient to meet the needs of these applications. Edge cloud technology has emerged and is gaining widespread use for this reason.

Edge cloud technology, also referred to as edge cloud computing technology, utilizes the core of cloud computing and the capabilities of edge computing to establish a cloud computing platform using edge facilities for performing data processing and computing. Through the use of edge cloud technology, it is feasible to offer edge cloud computing infrastructure services including computing, storage, network, accelerators, etc., as well as edge cloud computing platform services such as container services, big data services, artificial intelligence services, real-time communication (RTC) services, video AI, and audio and video communication.

However, in the current edge cloud-based system, the client terminal is still responsible for many tasks like data computation and execution. Therefore, how to reduce the client terminal's task burden with the help of edge cloud technology to improve its running speed and optimize the client terminal's performance has become an urgent issued to be solved in the related field.

### SUMMARY

In view of the foregoing, embodiments of the present disclosure provide a task execution solution to address at least part of the issues identified above.

According to the first aspect of embodiments of the present disclosure, it is provided a task execution method, applied to a client terminal, wherein the method includes: detecting an execution trigger code for a preset task during a process of executing a program code by means of a code execution environment; performing, according to the execution trigger code, a scheduling strategy querying, by means of the code execution environment, to obtain a scheduling strategy for the preset task; and scheduling, via an environment communication interface of the code execution environment, the preset task to be executed in a code execution environment of a cloud target device indicated by the obtained scheduling strategy.

Optionally, the step of scheduling, via the environment communication interface of the code execution environment, the preset task to be executed in the code execution environment in the cloud target device indicated by the obtained scheduling strategy includes: obtaining an environment execution code of the preset task by means of the code execution environment, wherein the environment execution code is a code executable in the code execution environment; and scheduling, via the environment communication interface of the code execution environment, the environment execution code of the preset task to be executed in the code execution environment in the cloud target device indicated by the obtained scheduling strategy.

Optionally, the step of scheduling, via the environment communication interface of the code execution environment, the environment execution code of the preset task to be executed in the code execution environment in the cloud target device indicated by the obtained scheduling strategy includes: sending, via the environment communication interface of the code execution environment, the environment parameter of the code execution environment of a client terminal and the environment execution code of the preset task to the environment communication interface of the code execution environment in the cloud target device indicated by the obtained scheduling strategy, so that the cloud target device initializes the code execution environment in the cloud target device according to the environment parameter and executes the environment execution code of the preset task upon completion of the initialization.

Optionally, the step of performing, according to the execution trigger code, the scheduling strategy querying, by means of the code execution environment to obtain the scheduling strategy for the preset task includes: sending a scheduling strategy query request for the preset task to at least one of an edge cloud and a center cloud, according to the execution trigger code and by means of the code execution environment; and receiving a query result in response to the scheduling strategy query request and obtaining the scheduling strategy for the preset task according to the query result;

Optionally, the step of performing, according to the execution trigger code, the scheduling strategy querying, by means of the code execution environment to obtain the scheduling strategy for the preset task includes: performing a client-side local scheduling strategy querying, according to the execution trigger code and by means of the code execution environment, and obtaining the scheduling strategy for the preset task.

Optionally, before the step of detecting the execution trigger code for the preset task during the process of executing the program code by means of the code execution environment, the method further includes: receiving a system call instruction containing a call of the preset task; and creating the code execution environment for a program corresponding to the system call instruction, so that the preset task is executed in the code execution environment.

Optionally, the system call instruction is disposed in a link library of a programming language used by an application to which the preset task belongs.

Optionally, the first aspect of task execution method further includes: receiving the cloud target device via the environment communication interface of the code execution environment thereof, and returning an execution result of the preset task to the environment communication interface of the code execution environment in the client terminal.

Optionally, the code execution environment is a WebAssembly standard-based code execution environment.

According to the second aspect of embodiments of the present disclosure, it is provided a task execution method, applied to a cloud, wherein the method includes: receiving, via an environment communication interface of a code execution environment, a scheduling strategy query request sent from a code security environment of a client terminal for a preset task; obtaining operation state information of the cloud in response to the scheduling strategy query request; determining a target device of the cloud that is capable of executing the preset task according to the operation state information, and determining a scheduling strategy according to the target device; and sending the scheduling strategy to a code execution environment in the client terminal via the environment communication interface of the code execution environment in the cloud.

Optionally, the second aspect of the task execution method further includes: receiving, via the environment communication interface of a code execution environment in the target device, an environment parameter of the code execution environment in the client terminal sent by the client terminal and an environment execution code of the preset task, wherein the environment execution code is a code executable in the code execution environment; and initializing the code execution environment in the target device according to the environment parameter, and executing the environment execution code of the preset task upon completion of the initialization.

Optionally, the second aspect of the task execution method further includes: returning an execution result of the preset task to the code execution environment in the client terminal via the environment communication interface of the code execution environment in the target device.

Optionally, the second aspect of the task execution method further includes: if it is determined that the target device capable of executing the preset task does not exist in the cloud according to the operation state information, then returning task rejection information to the code execution environment in the client terminal, via the environment communication interface of the code execution environment in the cloud, so that the client terminal executes the preset task in the code execution environment in the client terminal.

Optionally, the operation state information of the cloud includes load state information and/or network connection state information.

Optionally, the code execution environment is a WebAssembly standard-based code execution environment.

According to the third aspect of embodiments of the present disclosure, it is provided a task execution system, at least including: a client terminal and a cloud; wherein: the client terminal is configured to detect an execution trigger code for a preset task during a process of executing a program code by means of a code execution environment; performing, according to the execution trigger code, a scheduling strategy querying on the cloud, by means of the code execution environment, to obtain the scheduling strategy for the preset task; and scheduling, via an environment communication interface of the code execution environment, the preset task to be executed in the code execution environment of a cloud target device indicated by the obtained scheduling strategy; and the cloud is configured to receive, via an environment communication interface of a code execution environment in the cloud, a scheduling strategy query request sent from the client terminal for the preset task; determine and return a scheduling strategy to the code execution environment in the client terminal in response to the scheduling strategy query request; and execute the preset task scheduled by the client terminal, by means of the code execution environment in the target device indicated by the scheduling strategy.

Optionally, the client terminal is configured to obtain an environment execution code of the preset task by means of the code execution environment in the client terminal, wherein the environment execution code is a code executable in the code execution environment; and send the environment execution code of the preset task to the code execution environment in the target device for execution via the environment communication interface of the code execution environment.

Optionally, the code execution environment is a WebAssembly standard-based code execution environment.

According to the fourth aspect of embodiments of the present disclosure, it is provided an electronic device, including: a processor, a memory, a communication interface and a communication bus, wherein the processor, the memory and the communication interface communicate through the communication bus; and the memory is configured to store at least one executable instruction, wherein the executable instruction cause the processor to execute an operation corresponding to the task execution method according to the first aspect or the second aspect of the present disclosure.

According to the fifth aspect of embodiments of the present disclosure, a computer storage medium is provided, wherein a computer program is stored on the computer storage medium, and when the program is executed by the processor, the task execution method according to the first aspect or the second aspect of the present disclosure is implemented.

According to the fifth aspect of embodiments of the present disclosure, a computer program product is provided, including a computer instruction, wherein the computer instruction instructs a computing device to execute an operation corresponding to the task execution method according to the first aspect or the second aspect of the present disclosure.

According to the task execution solution provided by embodiments of the present disclosure, in order to reduce the task execution load of the client terminal, a code execution environment may be disposed in the devices of both of the client terminal and the cloud, wherein the code execution environment may be mainly used in the process of executing the program code, and the code execution environments of the client terminal and the cloud are usually the same, so that the tasks that are executable in the client terminal can also be executed in the cloud. In view of this, on the one hand, if the client terminal, by means of code execution environment, detects an execution trigger code of a preset task during the execution of the program code through its code execution environment, which means that the preset task needs to be executed, and at this time, the client terminal still inquires about and obtains a scheduling strategy for the preset task by means of the code execution environment to determine that the preset task is to be scheduled to be executed to a certain target device in the cloud. Since the performance of the cloud device is usually better than that of the client terminal, the execution of the preset task by the cloud reduces the task execution load of the client terminal at the same time improving the execution efficiency of the preset task and its running speed, which in turn optimizes the client terminal performance. On the other hand, the client terminal and the cloud interact directly with each other through the code execution environment in the two, so that the preset task can be executed by the code execution environment in the target device in the cloud without additional processing, which further improves the execution efficiency of the preset task. Moreover, the client terminal may subsequently provide task feedback based on the execution results of the preset task of the cloud device, and since the preset task is executed with high efficiency, the task feedback efficiency is also high, thereby overall improving the execution speed and efficiency of the preset task, as well as improving the running speed of the client terminal, and c the performance of the client terminal.

### BRIEF DESCRIPTION OF THE DRAWINGS

Aspects of the embodiments of the present disclosure are best understood from the following detailed description when read with the accompanying drawings. It should be noted that, the drawings discussed below represent only a selection of the embodiments included in the present disclosure, and other drawings may be obtainable by a person having ordinary skill in the art based on these drawings.

FIG. 1 is a schematic diagram illustrating an exemplary system for use in the task execution method according to embodiments of the present disclosure;

FIG. 2A is a flowchart illustrating a task execution method according to embodiment 1 of the present disclosure;

FIG. 2B is a schematic diagram illustrating an exemplary scenario in the embodiment of FIG. 2A;

FIG. 3A is a flowchart illustrating a task execution method according to embodiment 2 of the present disclosure;

FIG. 3B is a schematic diagram illustrating a task execution process in the embodiment of FIG. 3A;

FIG. 4 is a flowchart illustrating a task execution method according to embodiment 3 of the present disclosure; and

FIG. 5 is a schematic diagram illustrating the structure of an electronic device according to embodiment 5 of the present disclosure.

### DETAILED DESCRIPTION

In order to make a person skilled in the art better understand the technical solutions in the embodiments of the present disclosure, the technical solutions in the embodiments of the present disclosure is clearly and thoroughly described below with reference to the accompanying drawings of the embodiments of the present disclosure. It is apparent that the described embodiments are only a part of embodiments of the embodiments of the present disclosure, but not all of the embodiments. All other embodiments obtained by a person of ordinary skill in the art in view of the embodiments of the embodiments of the present disclosure should fall within the scope of protection of the embodiments of the present disclosure.

The specific implementation of the embodiments of the present disclosure is further described below with reference to the drawings of the embodiments of the present disclosure.

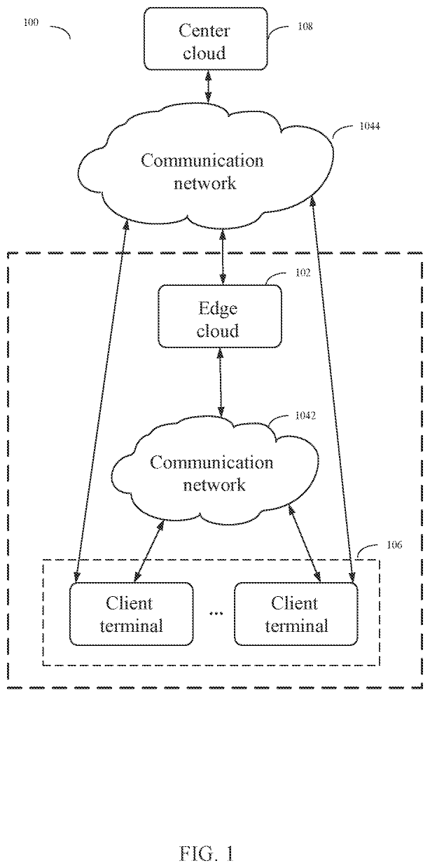

FIG. 1 illustrate an exemplary system for use in the task execution method according to embodiments of the present disclosure. As shown in FIG. 1, the edge cloud system 100 may include an edge cloud 102, a communication network 1042 and/or one or more client terminals 106, and there are a plurality of client terminals illustrated in FIG. 1. Furthermore, the edge cloud system may be further connected to a center cloud 108 via a communication network 1044, and the client terminal 106 in the edge cloud system 100 may communicate with the center cloud 108 via the edge cloud 102 or communicate with the center cloud directly.

The edge cloud 102 may be implemented as a server or server cluster configured to process computation, and store information, data, program and/or any other suitable types of contents. In certain embodiments, the edge cloud 102 may perform any suitable functions. For example, in certain embodiments, the edge cloud 102 may be configured to share the data calculation and processing tasks of the client terminal, so as to reduce the load of the client terminal and the software and hardware performance requirements for the client terminal, thereby reducing the implementation cost of the client terminal. As an optional example, in some embodiments, the edge cloud 102 may be used to interact, by means of the code execution environment, with the code execution environment in the client terminal 106 and may receive certain tasks to be performed of the client terminal 106 and execute these tasks in the code execution environment in the edge cloud 102.

In some embodiments, the communication network 1042 may be any suitable combinations of one or more wired and/or wireless networks. For example, the communication network 1042 can include any one or more of the following: the internet, intranet, wide area network (WAN), local area network (LAN), wireless network, digital subscriber line (DSL) network, frame relay network, asynchronous transfer mode (ATM) network, virtual private network (VPN), and/or any other suitable communication networks. The communications network 1044 may also be any suitable combinations of one or more wired and/or wireless networks. For example, the internet, wide area network (WAN), wireless network, etc. The client terminal 106 may be linked to the communication networks 1042 and 1044 via one or more communication, and the communication networks 1042 and 1044 may can be linked to the edge cloud 102 and the center cloud 108 via one or more communication links. The communication link may be any communication link suitable for communicating data between the client terminal 106 and the edge cloud 102 and the center cloud 108, such as a network link, a dialing link, a wireless link, a hardwired link, any other suitable communication links, or any suitable combinations of such links.

The client terminal 106 may include any one or more client terminals that may perform tasks such as data processing and data computing. In some embodiments, the client terminal 106 may include any suitable types of devices. For example, in some embodiments, the client terminal 106 may include a smart internet-of-things (IoT) device, a mobile device, a tablet computer, a laptop computer, a desktop computer, a wearable computer, a game console, a media player, a vehicle entertainment system, and/or any other suitable types of client terminals. In certain embodiments, the client terminal 106 may be used to implement a client terminal that interacts with the code execution environments in the edge cloud 102 and the central cloud 108 by means of its own code security environment to implement task scheduling and execution.

Although both the edge cloud 102 and the center cloud 108 are illustrated as one device, in some embodiments, any suitable numbers of devices may be used to perform the functions performed by the edge cloud 102 and the center cloud 108. For example, in certain embodiments, a plurality of devices may be used to implement the functions performed by the edge cloud 102. Alternatively, a plurality of devices may be used to implement the functions performed by the center cloud 108.

In the foregoing system, the code execution environment is configured to run a service for a code, and may be implemented by an appropriate execution environment tool, such as WebAssembly Runtime, JavaScript Runtime, etc. However, unlike conventional code execution environments that can only communicate with local external environments (environments other than the code execution environment), the code execution environment in the embodiments of the present disclosure may, via the environment communication interface arranged therein, communicate directly with the environment communication interface of the code execution environment in other devices, which greatly improves the communication efficiency and speed, and because it is environment-to-environment communication, the subsequent code does not need to be converted inside or outside the environment and can be directly transferred from one device to another device for operation. Furthermore, the code execution environment in the embodiments of the present disclosure is extended with new functions to perform task-specific scheduling strategy querying and interactions, and may transmit tasks to be implemented in the corresponding target device based on the results of the queries and interactions. For example, the client terminal 106 may send a scheduling strategy query request to the code execution environment in the edge cloud 102 and/or the center cloud 108 by means of its own code security environment, and may send the corresponding task to be executed to the code execution environment in the corresponding edge cloud 102 and/or the center cloud 108 for execution after obtaining the result, thereby realizing task scheduling.

Based on the foregoing system, embodiments of the present disclosure provide a task execution method, which is described below by means of a plurality of embodiments.

### EMBODIMENT 1

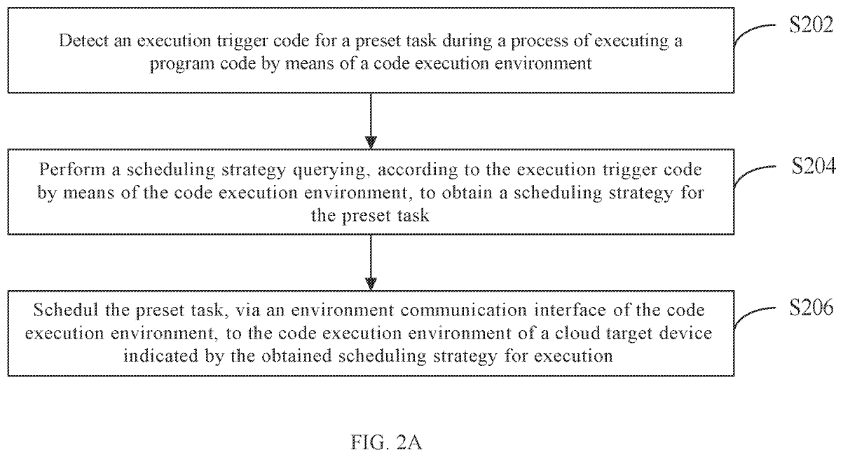

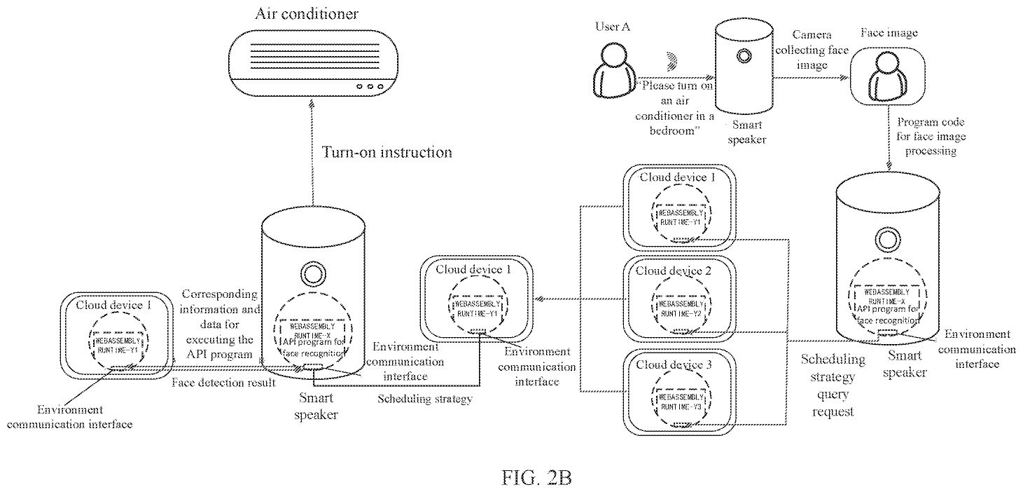

Reference is made to FIG. 2A, which is a flowchart illustrating the steps of a task execution method according to the first embodiment of the present disclosure.

In the present embodiment, the task execution method according to embodiments of the present disclosure is described from the perspective of a client terminal of an edge cloud system, wherein the task execution method includes the steps as follows.

Step S202: detecting an execution trigger code for a preset task during a process of executing a program code by means of a code execution environment.

In the embodiments of the present disclosure, the client terminal needs to be capable of supporting a code execution environment so as to run a program code therein. The code execution environment may be preset and then initialized when there is a program in need of using such a code execution environment, or may be created and initialized for a program when there is a program in need of using such a code execution environment to support its operation. The code execution environment is provided for use by the program after initialization.

In a specific implementation, the code execution environment may be implemented by a person skilled in the art using a suitable tool according to the actual situation of the client terminal, for example, implemented by WebAssembly Runtime or JavaScript Runtime or other Runtimes.

In one feasible approach, the code execution environment may be implemented as a Web Assembly standard-based code execution environment.

WebAssembly is a standardized byte file format defined by the W3C, which can compile programming languages such as C++ into the WebAssembly byte format (also known as byte code) and run in WebAssembly Runtime; and support the calling of the WebAssembly code module through other languages, such as JavaScript. At its core, it is a multi-application scenario-oriented virtual instruction architecture that can be embedded into different application environments to support high-performance Web applications. As a virtual machine and execution environment, WebAssembly allows loaded pages to run as natively compiled code, thus improving Web performance and power consumption. As a result, WebAssembly can achieve near-native speed performance and optimize load time. WebAssembly Runtime is WebAssembly's runtime environment, which can be a runtime environment such as a virtual machine running WebAssembly code. WebAssembly provides sandbox capabilities so that when a program is compiled into a WASM code module and then loaded into WebAssembly Runtime, the WASM code module runs in its private sandbox. Also, because the standardized byte file format of WebAssembly can also be considered as a low-level programming language, but unlike machine language, it can use more characters, WebAssembly has better flexibility and extensibility than machine language. Because of its flexibility and extensibility, it can be set up accordingly to meet different application requirements. Further, because no matter whether the use of high-level language code or the use of interpreted language code can be converted to the final machine language code execution by means of WebAssembly, that is, high-level language code and interpreted language code and WebAssembly bytecode do not have a direct interoperability, so that Web Assembly Runtime can also be effective on code isolation, thus realizing the security of the code execution environment. Because the WebAssembly standard is more mature, applying it to the realization of the code execution environment can also greatly save the cost for realization the present solution and reduce the research and development expenses.

However, as described above, other code execution environments created based on standards similar to WebAssembly standards and code execution environment of other languages may also be applicable to the solutions of the embodiments of the present disclosure.

Based on the constructed code execution environment, the program code may run; for example, if the code execution environment is set up in in a browser frame, it can be combined with a JS engine to run the web page code while parsing; that is, after parsing by the JS engine, the code will be handed over to the code execution environment to run. Similarly, the code in other languages can also be run by the code execution environment.

However, the nature of the code running in this code execution environment is still the program code for completing some tasks, and therefore, the code execution environment may detect such program code to determine whether the program code for a preset task exists. In this embodiment, the program code for the preset task is usually a code that needs to be handed over to the cloud (which may include at least one of the edge cloud 102 and the center cloud 108) for execution, such as a code that may be handed over to the edge cloud 102 for execution, or a code that is handed over to the center cloud 108 for execution, or a code that is partially handed over to the edge cloud 102 for execution and partially handed over to the center cloud 108 for execution. In practice, a preset task may be set by a person skilled in the art according to actual needs; for example, a task that requires consuming more computing power or resources may be taken as a preset task. However, the present embodiment is not limited thereto, and other types of tasks may also be applicable to the solutions of the embodiments of the present disclosure.

The execution of the preset task is usually triggered by a certain code, such as a call code, an instruction code, a trigger instruction, and the like, and in the process of executing the program code in the code execution environment, if the trigger execution codes corresponding to the preset task are detected, it is indicated that the preset task needs to be executed, and needs to be scheduled to the cloud for execution. Therefore, the code execution environment will be triggered to perform the operations of steps S204-S206.

Step S204: performing a scheduling strategy querying, according to the execution trigger code by means of the code execution environment, to obtain a scheduling strategy for the preset task.

In the embodiments of the present disclosure, the code execution environment not only has a conventional code running support function, but also has a scheduling function, including a scheduling strategy querying function and a scheduling execution function, wherein the scheduling strategy is used to indicate that a preset task is to be scheduled to run in a certain target device in the cloud. However, the specific device to which the task is to be scheduled needs to be determined by the client terminal through the scheduling strategy querying. The scheduling strategy querying can usually be made by the client terminal to the cloud (e.g., the edge cloud and/or center cloud), but in some cases, the client terminal may also configure the scheduling strategy locally, in which case the client terminal can also make a local scheduling strategy querying. Configuring the scheduling strategy in the cloud can effectively realize the scheduling execution of the preset tasks, but also realize the sharing of scheduling strategy and save system resources. If the scheduling strategy is also configured locally on the client terminal side, it provides greater scheduling flexibility for the client terminal users and facilitates the client terminal users to realize their personalized scheduling needs.

It should be noted that, in the case that the cloud and the client terminal are both configured with the scheduling strategy, a priority may be set for the scheduling strategy at both ends, and the specific setting rule may be set by a person skilled in the art according to actual needs, which is not limited in the embodiments of the present disclosure.

For example, if the cloud is configured with a scheduling strategy, when the scheduling strategy is queried, the client terminal's code execution environment sends a query request to the cloud (which may be all or part of the devices in the cloud) via the environment communication interface, and after the cloud receives the query request via the environment communication interface of the cloud's code execution environment, the cloud may determine the target device that can execute the preset task based on the preset rules, and further generates a scheduling strategy based on the information of the determined target device, and returns the scheduling strategy to the client terminal's code execution environment via the environment communication interface of the cloud, thereby realizing returning the scheduling strategy to the client terminal.

Step S206: scheduling the preset task, via an environment communication interface of the code execution environment, to the code execution environment of a cloud target device indicated by the obtained scheduling strategy for execution.

As discussed above, the scheduling strategy contains information of the target device capable of executing the preset task. The target device is usually a device in the edge cloud or a device in the center cloud, and a code execution environment is also set up in said device. The information of the target device may include but is not limited to an identifier, an address, information of an environment communication interface of the code execution environment in the target device, and the like. Based on this, the client terminal may directly perform interaction based on the code execution environment.

After the client terminal receives the scheduling strategy, it may obtain the information of the target device contained therein and send such information and data to the environment communication interface of the code execution environment in the target device via the environment communication interface of the code execution environment in the client terminal, so that the preset task is directly handed over to the target device for execution. For example, the byte code of the WebAssembly is directly executed by the Web Assembly Runtime of the target device without the need of additional operations such as code conversion.

In the following, the above process is illustrated exemplarily with a specific scenario, as shown in FIG. 2B.

In FIG. 2B, it is assumed that the client terminal is a smart speaker, which is required to determine, by face recognition, whether a user sending instructions to it is a specific user (in this example, a user A). If the user is the specific user (i.e., user A), a plurality of smart home appliances communicatively connected thereto are controlled to carry out an operation indicated by the said instructions according to the instructions of the user A. In the present example, tasks such as face recognition that consume a large amount of computing power and resources will be left to be done by the edge cloud communicatively connected to the smart speaker, whereby the running speed of the smart speaker can be improved, its performance can be optimized, and the requirements for its hardware and software performance can be reduced.

For example, the smart speaker firstly collects a voice instruction (such as “please turn on an air conditioner in a bedroom”) by means of a voice collection device such as a microphone; then, the smart speaker collects the face in front of the smart speaker through a camera thereof. In this example, it is assumed that the processing of the face image is performed by a code execution environment local to the smart speaker, and the operation of performing face recognition in the face image processing is encapsulated into an API program (the WASM program code in the present example). In addition, the program code corresponding to the face image processing further includes an instruction code for instructing the API program of the face recognition operation to perform scheduling through the code execution environment in the intelligent sound box (the WebAssembly Runtime in the present example). In one approach, the indication code may notify the code execution environment in advance in an appropriate manner that the API program is to be scheduled for execution. However, the present embodiment is not limited thereto, and other means of notification are also applicable.

Based on this, the smart speaker creates a code execution environment such as Web Assembly Runtime-X to run the program code for face image processing in the WebAssembly Runtime-X. When the program code is run to the code segment calling the API program, the Web Assembly Runtime-X determines that the API program needs to be scheduled to the cloud for execution according to pre-obtained information. Then, the WebAssembly Runtime-X sends a scheduling strategy query request to the code execution environments in the devices 1, 2, and 3 (WebAssembly Runtime-Y1, WebAssembly Runtime-Y2 and WebAssembly Runtime-Y3, respectively) in the edge cloud by means of its environment communication interface. After receiving the query request, the WebAssembly Runtime-Y1, the WebAssembly Runtime-Y2 and the WebAssembly Runtime-Y3 determine, according to its own load and/or network condition, whether an API program for face recognition can be executed; assuming that it is finally determined that the WebAssembly Runtime-Y1 can perform the execution, then it can be determined that the corresponding device 1 is the target device. Subsequently, a scheduling strategy may be generated based on the information of the device 1, such as an identifier, an address, an environment communication interface of the WebAssembly Runtime-Y1, etc. It should be noted that the generation of the scheduling strategy may be generated by any one of the devices 1, 2, and 3, or may be specified by a device that may perform a preset task, such as device 1. After the scheduling strategy is generated, the device 1 sends the scheduling strategy to the environment communication interface of the WebAssembly Runtime-X via its environment communication interface of the WebAssembly Runtime-Y1. The WebAssembly RunTime-x, after receiving the scheduling strategy, establishes a communication connection with the environment communication interface of the WebAssembly Runtime-Y1 via the environment communication interface of the WebAssembly Runtime-X, and sends corresponding information and data for executing the API program to the WebAssembly Runtime-Y1. For example, the running environment parameters of the WebAssembly Runtime-X can be selected to be sent to the Web Assembly Runtime-Y1, so that the WebAssembly Runtime-Y1 can be initialized based on the environment parameters to form a running environment which is the same as the WebAssembly Runtime-X; and then the WASM code of the API program is sent from the Web Assembly Runtime-X to the WebAssembly Runtime-Y1 via the environment communication interfaces of the two. After the WebAssembly Runtime-Y1 receives the WASM code of the API program, it may directly execute the API program. In this example, the WebAssembly Runtime-Y1 will execute the API program, perform recognition on the face image collected by the smart speaker, and return the recognition result to the WebAssembly Runtime-X via the environment communication interfaces of both parties after obtaining the recognition result. In this example, it is set to determine by recognition that the face in the image is the face of the user A. WebAssembly Runtime-Y1 returns the result to WebAssembly Runtime-X, and WebAssembly Runtime-X, upon receiving the result, can perform subsequent processing based on the result, such as returning a determined signal and instruction to the smart speaker, instructing the smart speaker to send a turn-on instruction to the bedroom air-conditioner to turn on the bedroom air-conditioner to which it is connected.

As can be appreciated, in this example, the smart speaker does not need to deal with program codes such as face recognition and other program codes that consume a lot of computing power and resources, and only needs to have basic functions such as voice acquisition, recognition, image acquisition, device control, etc., which greatly reduces the performance requirements for the smart speaker and improves its data processing speed.

The foregoing embodiment is discussed using the smart speaker as an example, but a person having ordinary skill in the art should understand that other devices such as the path planning of the sweeping robot, the AI processing of mobile terminals such as cell phones and other high-computing power and high-energy consumption processing, etc., can be handed over to the cloud by way of the embodiments of the present disclosure.

By means of the present embodiment, in order to reduce the task execution load of the client terminal, a code execution environment may be configured in the devices in both the client terminal and the cloud, wherein the code execution environment may be mainly used in the execution process of the program code, and the code execution environments of the client terminal and the cloud are usually the same, so that a task that is executable in the client terminal can also be executed in the cloud. Based on this, on the one hand, if the client terminal detects a triggering execution code for a preset task during the process of executing the program code by means of its code execution environment, it indicates that the preset task needs to be executed, and at this time, the client terminal still inquires about and obtains a scheduling strategy for the preset task by means of the code execution environment so as to determine that the preset task is to be scheduled to a certain target device in the cloud for execution. Since the performance of the cloud device is usually better than that of the client terminal, the execution of the preset task by means of the cloud reduces the task execution load of the client terminal while also improving the execution efficiency of the preset task and its running speed, which in turn optimizes the client terminal performance. On the other hand, the client terminal and the cloud interact directly with each other by means of the code execution environments in the two, so that the preset task can be executed by the code execution environment in the target device in the cloud without additional processing, which further improves the execution efficiency of the preset task. Moreover, the client terminal may subsequently provide a task feedback based on the execution results of the preset task by the cloud device, and since the preset task is executed with high efficiency, the task feedback efficiency is also high, thereby improving the overall execution speed and efficiency of the preset task, as well as improving the running speed of the client terminal and optimizing the performance of the client terminal.

### EMBODIMENT 2

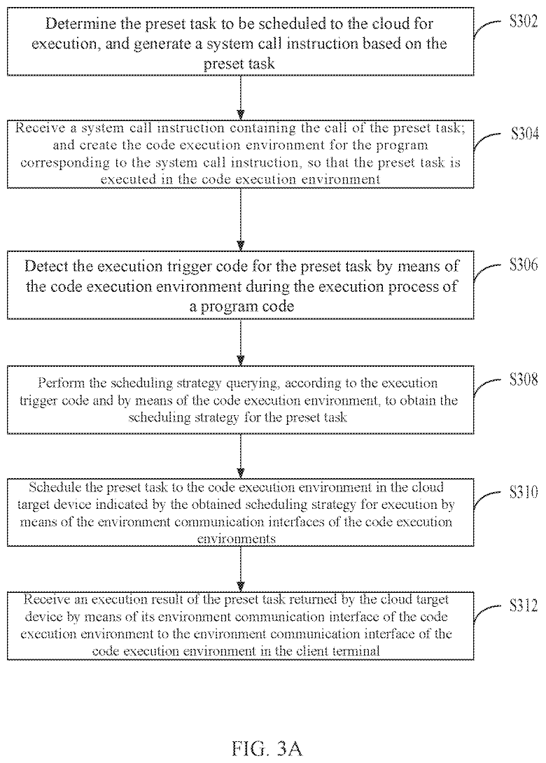

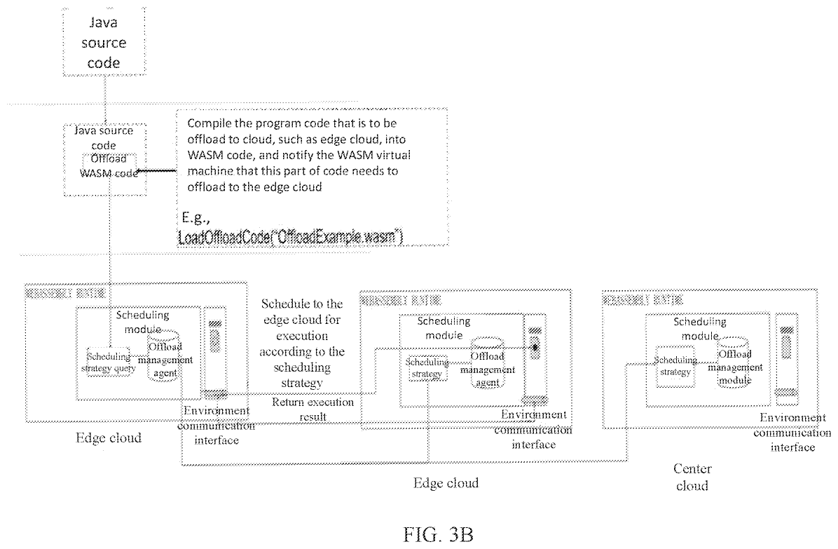

Refer to FIG. 3A, which is a flowchart illustrating the steps of a task execution method according to the second embodiment of the present disclosure.

In the present embodiment, the task execution method according to embodiments of the present disclosure is still described from the perspective of a client terminal, wherein the task execution method includes the steps as follows.

Step S302: determining the preset task to be scheduled to the cloud for execution, and generate a system call instruction based on the preset task.

As discussed above, the preset task may be set by persons of ordinary skill in the art depending on the actual needs, and in order to reduce the client terminal load and increase the running speed, it is feasible to set task that requires consuming more computing power or resources as the preset task. However, the present embodiment is not limited thereto, and other tasks that are better executed in the cloud or contribute to affecting the performance of the terminal may be set as preset tasks.

After determining the preset task, it may be feasible to generate a corresponding system call instruction based on the preset task. On the one hand, the system call instruction may be configured to call the function module where the preset task is located; if the preset task is encapsulated as an API program, then the system call instruction may implement the corresponding functions by means of calling the API program to call the execution of the preset task, so as to achieve the corresponding functions. On the other hand, the system call instruction may further instructed that the called preset task needs the code execution environment for running, and may be scheduled to the cloud for execution by means of the code execution environment.

The system call instruction may be implemented using any suitable approaches, such as implemented by an SDK or a Library approach. Optionally, the system call instruction is disposed in a link library of a programming language used by an application to which the preset task belongs. For example, for the programming language library extension function used by the application to which the preset task belongs, it supports scheduling the program code of the preset task to the edge cloud or the center cloud for execution. By means of the extended Library function, the API that can be called by the developer is supplied to load the program code that needs to be scheduled to the cloud for execution, which can be simply implemented according to the developer programming language (such as Java, C++) and the like, which is convenient to implement and low in implementation cost.

Step S304: receiving a system call instruction containing the call of the preset task; and creating the code execution environment for the program corresponding to the system call instruction, so that the preset task is executed in the code execution environment.

Since the system call instruction may indicate that the program code should run by means of the code execution environment, after receiving the system call instruction, the code execution environment may be created according to the system call instruction, which is to be used by the corresponding program code (for example, part or all of the program code of the program where the preset task is located) for running.

In one feasible approach, the code execution environment is a WebAssembly standard-based code execution environment. The code execution environment based on the WebAssembly standard can effectively guarantee the security of code execution and realize the environment requirements for code execution in a simple and low-cost manner, in addition to providing a code execution environment.

Taking WebAssembly runtime as an example, a private WebAssembly sandbox for a preset task can be created according to a system call instruction, so that the program code of the preset task is executed in the private sandbox.

Since the preset tasks need to be executed in the code execution environment, the relevant code segments containing the preset task can be compiled into the environment execution code (i.e., the code that can be run in the code execution environment) in advance. Still taking the example where the code execution environment is WebAssembly Runtime, the relevant code segment can be compiled into WASM code (i.e., WebAssembly byte code) so that it can be run directly in WebAssembly Runtime.

Step S306: detecting the execution trigger code for the preset task by means of the code execution environment during the execution process of a program code.

The specific implementation of this step can be referred to the relevant description in Step S202 in Embodiment 1 and will not be repeated herein.

Step S308: performing the scheduling strategy querying, according to the execution trigger code and by means of the code execution environment, to obtain the scheduling strategy for the preset task.

In one feasible approach, the present step may be implemented as: sending a scheduling strategy query request for the preset task to an edge cloud and/or a center cloud according to the execution trigger code by means of the code execution environment; receiving a query result in response to the scheduling strategy query request, and obtaining the scheduling strategy for the preset task according to the query result. In this approach, the cloud processes the scheduling strategy query request and generates the scheduling strategy, which not only facilitates the sharing of data relevant to the scheduling strategy but also reduces the data process load of the client terminal and increases the client terminal running speed.

In another alternative approach, the present step may be implemented as: performing a client-side local scheduling strategy querying according to the execution trigger code, by means of the code execution environment, and obtaining the scheduling strategy for the preset task. In this approach, the client terminal also encompasses the functionalities for the determination and generation of the scheduling strategy, thereby providing more flexibility to the client terminal user performing the preset task scheduling.

The scheduling strategy querying may be implemented using any suitable messaging methods, including but are not limited to: http message, https message, RPC message, middleware message and so on.

When the first feasible approach discussed above is adopted, a query request message may be sent by the client terminal by means of its code execution environment to the code execution environments in some or all of the devices in the cloud. Then, after receiving the query request message by means of the code execution environments in the cloud, the cloud device may determine a target device that can execute said preset task according to its own operation state information, such as load state information, network state information, etc., generate a scheduling strategy based on the target device, and may send it to the client terminal's code execution environment by means of the code execution environment in the target device. It is to be noted that in the embodiments of the present disclosure, if not otherwise specified, the interaction between different code execution environments may be realized by sending or receiving data by means of corresponding environment communication interfaces.

The generated scheduling strategy usually includes at least information of the target device, including but not limited to: identifier information, address information, information of the environment communication interface of the code execution environment in the target device, and the like.

Step S310: scheduling the preset task to the code execution environment in the cloud target device indicated by the obtained scheduling strategy for execution by means of the environment communication interfaces of the code execution environments.

In the embodiments of the present disclosure, the code execution environment in the client terminal and the code execution environment in the cloud are the environments of the same type (e.g., both are WebAssembly Runtime or both are JavaScript Runtime). Therefore, the program code may be transmitted to the target device for direct execution.

To ensure efficient realization of direct execution of the preset task, in one feasible approach, the environment execution code of the preset task may be obtained by means of the code execution environment in the client terminal, wherein the environment execution code is the code that may be executed in the code execution environment; the environment execution code of the preset task is scheduled, by means of the environment communication interface of the code execution environment, to the code execution environment of cloud target device indicated by the obtained scheduling strategy for execution. In this way, the preset task can run in the code execution environment in the cloud target device without additional code processing and conversion.

In one specific implementation, the environment parameters of the client terminal's code execution environment and the environment execution code of the preset task may be sent to the environment communication interface of the code execution environment in the cloud target device indicated by the scheduling strategy by means of the environment communication interface of the client terminal's code execution environment, so as to cause the cloud target device to initialize the cloud target device's own code execution environment according to the environment parameters, and to execute the environment execution code of the preset task upon completion of the initialization. In this way, the consistency between the code execution environment in the cloud target device and the code execution environment in the client terminal can be ensured so as to facilitate the direct and seamless execution of the preset task.

Step S312: receiving an execution result of the preset task returned by the cloud target device by means of its environment communication interface of the code execution environment to the environment communication interface of the code execution environment in the client terminal.

After the execution of the preset task is completed in the code execution environment in the cloud target device, an execution result is obtained, such as a face recognition result, a path planning result, a semantic analysis result, and so on. The cloud target device sends the execution result to the environment communication interface of the code execution environment in the client terminal by means of the environment communication interface of the code execution environment in the cloud target device. After receiving the execution result, the client terminal may perform subsequent operations based on the execution result; for example, perform subsequent program calls based on the execution result or directly feedback the execution result to the corresponding program, etc., and the embodiments of the present application is not limited thereto.

In the following, the above process is illustrated by taking the task execution process of a preset task as an example, as shown in FIG. 3B.

As can be seen in FIG. 3B, a scheduling module is disposed in each of the client terminal, the edge cloud and the center cloud; in the present example, the scheduling module of the client terminal is configured to be in charge of the querying and execution of the scheduling strategy, the querying and execution of the scheduling strategy may be implemented by the functions extended by the function extension of the client terminal's programming language library for the application to which the preset task belongs; for example, the extended function may determine the target device for executing the program code of the preset task (such as scheduling it to be executed on the edge cloud, or scheduling it to be executed on the center cloud, and so on). Specifically, with respect to the extended function of the programming language library used by the application to which the preset task belongs, enable it to support scheduling of the program code for the preset task for execution in the edge cloud or the center cloud. For example, an API that can be called by a developer to load the program code that needs to be called for execution on the cloud may be provided to enable the developer to develop the relevant extension library according to a specific developer programming language (e.g., Java, C++ and the like).

In the present embodiment, on the one hand, the scheduling strategy is deployed on the center cloud and the edge cloud, and the scheduling module of the client terminal may inquire about and obtain the relevant scheduling strategy by means of edge cloud and/or center cloud. On the other hand, the client terminal is also statistically configured with a scheduling strategy for performing a local scheduling strategy querying.

In addition, the client terminal of the present example is further configured with a remote code call function module, which is in charge of sending the program code of the preset task of the client terminal to the edge cloud or the center cloud for execution and obtaining the execution result. When implemented, such function module may realize functions including: notifying the code execution environment in the cloud of the information and data about the preset task to be executed; sending environment parameters of the local code execution environment to the cloud to cause the cloud to initialize its own code execution environment and execute the preset task; and, upon the completion of the execution in the cloud, receiving the execution result returned by the cloud by means of the environment communication interfaces between the code execution environments.

The client terminal, the edge cloud and the center cloud all support the code execution environments and all are configured with the environment communication interfaces between the code execution environments, so as to facilitate the communication function between the code execution environments of the client terminal, the edge cloud and the center cloud.

In the present embodiment, still taking the example where the code execution environment is WebAssembly Runtime, and the task execution process is discussed below based on such configuration. The process includes the steps as follows.

(1) Compile the program code of the preset task of the client terminal (such as the code of the tasks with high computational complexity in the application) into a WebAssembly code module, and load the WebAssembly code module by means of the interface (API) provided by the extension function of the Library of the programming language used for the application, and instruct that the WebAssembly code module is to be executed in the cloud (this operation is also known as Offload).

Whether it is JAVA source code, C++ source code, or code from another programming language, the code can be compiled into WASM code, and it can be assumed that this part of the code is the code that needs to be scheduled to the cloud for execution.

In the present embodiment, the JAVA source program code is used as an example, which is compiled into WASM code, i.e., the “offload wasm code” shown in the drawing.

(2) The scheduling module in the WebAssembly Runtime of the client terminal queries the scheduling module located in the edge cloud or the center cloud by means of the network and decides in which edge cloud or the center cloud to execute the WebAssembly code module of this Offload according to the scheduling strategy provided by the scheduling module of the edge cloud or the center cloud.

(3) The scheduling module located in the edge cloud or the center cloud provides a response to the scheduling strategy querying sent by the client terminal WebAssembly Runtime and returns the scheduling strategy to the client terminal. In this embodiment, the scheduling strategy may be determined based on parameters such as the operational load state of the edge cloud or the center cloud, the network connection between the client terminal and the edge cloud or the center cloud, etc.

(4) The client terminal sends the WebAssembly code module of Offload to the WebAssembly Runtime of the edge cloud or the center cloud via the network according to the received scheduling strategy.

(5) The WebAssembly Runtime of the edge cloud or the center cloud executes the Web Assembly code module of the Offload and returns the execution result to the WebAssembly Runtime of the client terminal via the network. In this step, an asynchronous execution mechanism can be used, i.e., the edge cloud or the center cloud executes the WebAssembly code module of the Offload does not block the execution of the client terminal program.

In addition, if the WebAssembly code module that needs to be Offloaded in the client terminal needs to be executed multiple times, each execution can follow the aforementioned process to flexibly determine the device that can execute the WebAssembly code module based on the network connectivity between the client terminal and the edge cloud or the center cloud, the load condition of the edge cloud or the center cloud, and so on. When the network connection condition between the client terminal and the edge cloud or the center cloud is poor, or the edge cloud or the center cloud does not have enough resources, the WebAssembly code module can fall back to the WebAssembly Runtime of the client terminal for execution. As a result, the flexible scheduling strategy can improve the running efficiency of client terminal program and enhance the robustness and reliability.

As can be seen from the above, in the present embodiment, the provision of Offload based on the granularity of the WebAssembly code module is easy to deploy with small changes to the original application; moreover, it can be suitable for a variety of applications with different design architectures and has good versatility; moreover, it can be easily and conveniently used in a wide range of scenarios based on the expansion of the WebAssembly Runtime, which has a good level of performance and maturity. Furthermore, the expansion is based on WebAssembly Runtime and has good performance and maturity, so it can be easily and readily used in various scenarios.

In addition, by means of the present embodiment, in order to reduce the task execution load of the client terminal, a code execution environment may be configured in devices in both the client terminal and the cloud, in which the code execution environments may be mainly used for the execution process of the program code, and the code execution environments of the client terminal and the cloud are usually the same, so that a task that may be executed in the client terminal can also be executed in the cloud. In view of this, on the one hand, if the client terminal detects an execution trigger code of a preset task during the process of executing the program code by means of its code execution environment, it indicates that the preset task needs to be executed, and at this time, the client terminal still inquires about and obtains a scheduling strategy for the preset task by means of the code execution environment to determine that the preset task is to be scheduled to a certain target device in the cloud for execution. Since the performance of the cloud device is usually better than that of the client terminal, the execution of the preset task by means of the cloud reduces the task execution load of the client terminal while also improving the execution efficiency of the preset task and its operation speed, which in turn optimizes the client terminal performance. On the other hand, the client terminal and the cloud interact directly with each other by means of the code execution environments in the two, so that the preset task can be executed by the code execution environment in the target device in the cloud without additional processing, which further improves the execution efficiency of the preset task. Moreover, the client terminal may subsequently provide task feedback based on the execution results of the preset task of the cloud device, and since the preset task is executed with high efficiency, the task feedback efficiency is also high, thereby improving the overall execution speed and efficiency of the preset task, as well as improving the running speed of the client terminal and optimizing the performance of the client terminal.

### EMBODIMENT 3

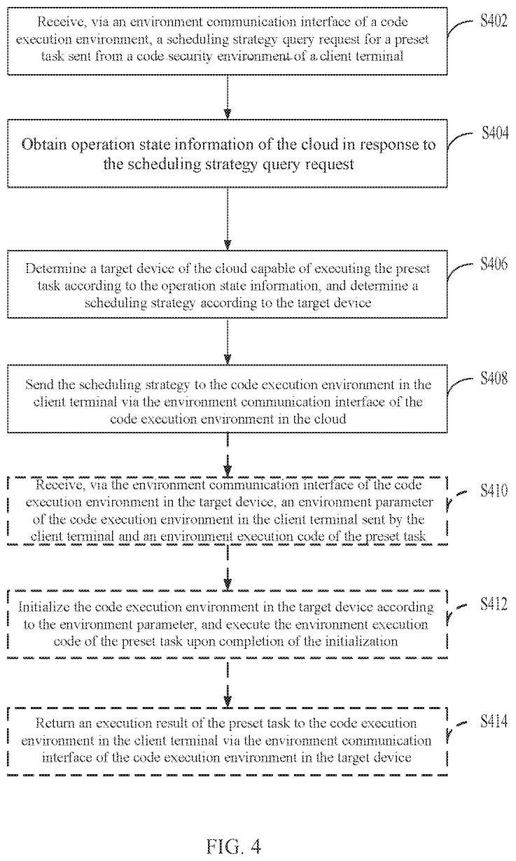

Reference is made to FIG. 4, which is a flowchart illustrating the steps of a task execution method according to the third embodiment of the present disclosure.

In the present embodiment, the task execution method according to embodiments of the present disclosure is described from the perspective of a cloud (an edge cloud or center cloud), wherein the task execution method includes the steps as follows.

Step S402: receiving, via an environment communication interface of a code execution environment, a scheduling strategy query request for a preset task sent from a code security environment of a client terminal.

When a preset task needs to be scheduled for execution in the cloud, the client terminal sends a scheduling strategy query request to the code execution environment of some or all of the devices in the cloud by means of its own code execution environment, and the cloud devices receive the scheduling strategy query request by means of the code execution environment.

The code execution environment-based interaction between the client terminal and the cloud device is realized via the environment communication interface of the respective code execution environment.

In one feasible approach, the code execution environment of both parties may be realized as a code execution environment based on the WebAssembly standard. The specific implementation of the code execution environment and the corresponding effect can be referred to the corresponding part of the description in the foregoing embodiments, and will not be repeated herein.

Step S404: obtaining operation state information of the cloud in response to the scheduling strategy query request.

In this embodiment, the operation state information of the cloud includes the load state information of the cloud device and/or the network connection state information. In this case, the load state information is used to indicate the current load state of the cloud device, such as busy, idle, general, or, alternatively, may be characterized by specific running load data such as computing power situation, CPU occupancy situation, and other data; and the network connection state information is used to indicate the network connection state of the cloud device and the client terminal, such as the network connection is normal, blocked, jammed, and so on. The embodiments of the present disclosure do not limit the specific expression forms of the load state information and the network connection state information. By means of the load state information and/or the network connection state information, it is possible to accurately determine whether a certain cloud device is suitable for executing a preset task of the client terminal.

Step S406: determining a target device of the cloud capable of executing the preset task according to the operation state information, and determining a scheduling strategy according to the target device.

As discussed above, it is possible to accurately determine a certain cloud device as the target device suitable for executing a preset task according to the operation state information, and after determining the target device, it is feasible to generate the corresponding scheduling strategy based on the information of the target device, wherein the scheduling strategy contains information of the target device, including but not limited to: identifier information, address information, information of the environment communication interface of the code execution environment in the target device, and the like.

The scheduling strategy may be generated by the target device or by another device that receives the scheduling strategy query request of the client terminal through the cloud.

Step S408: sending the scheduling strategy to the code execution environment in the client terminal via the environment communication interface of the code execution environment in the cloud.

In this step, if the scheduling strategy is generated by the target device, the scheduling strategy may be sent by the target device to the code execution environment in the client terminal via the environment communication interface of its own code execution environment. If the scheduling strategy is generated by another device, the scheduling strategy may be sent by the device that generated the scheduling strategy to the client terminal's code execution environment via the environment communication interface of said device's code execution environment. Of course, the client terminal's code execution environment also receives the scheduling strategy via its own environment communication interface.

The present method may optionally perform the steps as follows on the basis of the foregoing steps.

Step S410: receiving, via the environment communication interface of the code execution environment in the target device, an environment parameter of the code execution environment in the client terminal sent by the client terminal and an environment execution code of the preset task.

In the present embodiment, the environment execution code is a code executable in the code execution environment.

Step S412: initializing the code execution environment in the target device according to the environment parameter, and executing the environment execution code of the preset task upon completion of the initialization.

To ensure the consistency between code execution environments, the client terminal sends the environment parameter of its own code execution environment to target device, so that the target device may initialize the code execution environment in the target device according to the environment parameter, so that the target device may execute the environment execution code of preset task after the initialization.

It should be noted that the environment parameters and the environment execution code of the preset tasks may be sent by the client terminal via a message, then the target device receives them at one time and processes them separately to improve the transmission efficiency; alternatively, the environment parameters may be sent by the client terminal via a message first, and then the environment execution code of the preset tasks may be sent via another message to alleviate the load of network transmission.

Step S414: returning an execution result of the preset task to the code execution environment in the client terminal via the environment communication interface of the code execution environment in the target device.

The target device and the client terminal may still perform the interaction based on the code execution environment by means of each party's environment communication interface.

Furthermore, when performing Step S406, if it is determined, according to the operation state information, that there is no target device in the cloud that can execute the preset task (e.g., the load states of the devices in the cloud are all busy), then a task rejection information is returned to the client terminal's code execution environment via the environment communication interface of the code execution environment of the cloud, so as to enable the client terminal to execute the preset task in its own code execution environment. In the present step, the sending of the rejection information to the client terminal may be executed by any device in the cloud, which may usually be executed by a device with a better network connection state or a better load state, but may also be executed by other devices, and the embodiments of the present disclosure are not limited thereto.

With the present embodiment, the cloud collaborates with the client terminal to transfer preset tasks from the client terminal to the cloud for execution. The two interact via an environment communication interface by means of their respective code execution environments to realize efficient execution of the preset tasks. In this way, the overall execution speed and efficiency of the preset tasks are improved, the running speed of the client terminal is improved, and the performance of the client terminal is optimized.

### EMBODIMENT 4

Referring again to FIG. 1, a task execution system of embodiments of the present disclosure is described in view of the discussion in the foregoing embodiments.

As discussed above, the task execution system of the present embodiment is based on edge cloud technology, and the task execution system includes at least: a client terminal 106 and a cloud, which may include an edge cloud 102 and/or a center cloud 108.

Details of the present embodiment are discussed below.

The client terminal 106 is configured to detect an execution trigger code for a preset task during a process of executing a program code by means of a code execution environment; perform, according to the execution trigger code, a scheduling strategy querying to the cloud (i.e., the edge cloud 102 and/or the center cloud 108), by means of the code execution environment, to obtain a scheduling strategy for the preset task; and schedule, via an environment communication interface of the code execution environment, the preset task to be executed in the code execution environment of a cloud target device indicated by the obtained scheduling strategy.

The cloud (i.e., the edge cloud 102 and/or the center cloud 108) is configured to receive, via an environment communication interface of a code execution environment of a device in the edge cloud 102 and/or the center cloud 108, a scheduling strategy query request sent from the client terminal 106 for the preset task; determine and return a scheduling strategy to the code execution environment in the client terminal 16 in response to the scheduling strategy query request; and execute the preset task scheduled by the client terminal 106, by means of the code execution environment in the target device indicated by the scheduling strategy.

Optionally, the client terminal 106 is configured to obtain the environment execution code of the preset task by means of the code execution environment in the client terminal, wherein the environment execution code is a code executable in the code execution environment; and send the environment execution code of the preset task to the code execution environment in the target device for execution via the environment communication interface of the code execution environment.

Optionally, the code execution environment is a WebAssembly standard-based code execution environment.

It should be noted that the discussion of various parts of the system of the present embodiment is relatively simple, and the implementation of some functions of the relevant parts may refer to the relevant discussions in the foregoing embodiments of the present method, and will not be repeated herein.

The task execution system of the present embodiment can implement the corresponding task execution method in the foregoing embodiments of the present method, and has the advantages of the corresponding embodiments of the present method, and will not be repeated herein. Furthermore, the implementation of the functions of each part of the task execution system may refer to the corresponding discussions in the foregoing embodiments of the present method, and will not be repeated herein.

### EMBODIMENT 5

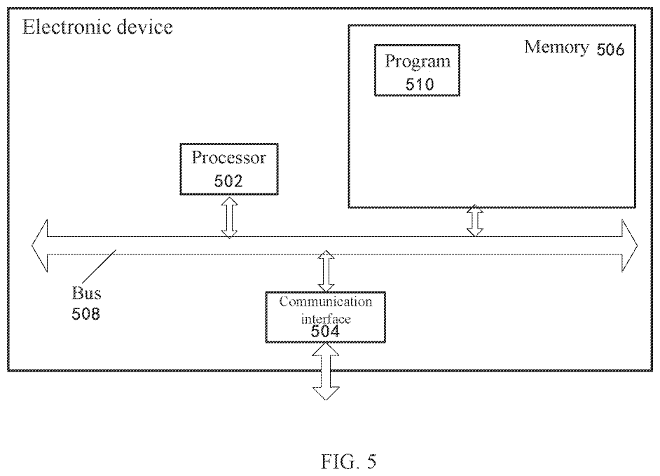

Reference is made to FIG. 5, which is a schematic diagram illustrating an electronic device according to the fifth embodiment of the present disclosure; however, the embodiments of the present disclosure are not specifically limited to any electronic devices.

As shown in FIG. 5, the electronic device may include: a processor 502, a communication interface 504, a memory 506, and a communication bus 508.

Details of the present embodiment are discussed below.

The processor 502, the communication interface 504 and the memory 506 communicate through the communication bus 508.

The communication interface 504 is configured to communicate with other electronic devices or servers.

The processor 502 is configured to execute a program 510, which may perform the related steps of the foregoing embodiments of the present task execution method.

In particular, the program 510 may include a program code, wherein the program code include computer operation instructions.

The processor 502 may be a central processing unit (CPU) or an application specific integrated circuit (ASIC), or one or more integrated circuits configured to implement embodiments of the present application. The one or more processors included in the smart device may be of the same type of processor, such as one or more CPUs; or may be different types of processors, such as one or more CPUs and one or more ASICs.

The memory 506 is configured to store the program 510. The memory 506 may include a high-speed RAM memory, or may also include non-volatile memory, such as at least one disk memory.

The program 510 may be specifically configured to cause the processor 502 to execute the task execution method described in any of the foregoing embodiments one through three.

The specific implementation of the steps in the program 510 can be referred to the corresponding discussions in the corresponding steps and units in the foregoing embodiments of the present task execution method, and will not be repeated herein. It is clear to persons having ordinary skill in the art that, for the convenience and brevity of the discussion, the specific work processes of the devices and modules discussed above can be referred to the corresponding discussions with respect to the foregoing embodiments of the present method, and will not be repeated herein.

Embodiments of the present disclosure also provide a computer program product, which includes a computer instruction that instructs a computing device to perform an operation corresponding to any of the task execution methods according to any of the foregoing embodiments of the present method.

It should be noted that, depending on the needs of the implementation, each component/step described in the embodiments of the present disclosure may be split into more components/steps, or two or more components/steps or some operations of the components/steps may be combined to form new components/steps to realize the purpose of the embodiments of the present disclosure.

The methods described above according to embodiments of the present disclosure may be implemented in hardware, firmware, or implemented as software or computer code that may be stored in a recording medium (such as a CD ROM, RAM, floppy disk, hard disk, or magnetic disc), or implemented as computer code downloaded over a network that was originally stored in a remote recording medium or non-transitory machine-readable medium and that will be stored in a local recording medium such that the methods described herein may be processed by such software stored on a recording medium using a general-purpose computer, a dedicated processor, or programmable or specialized hardware (such as an ASIC or FPGA). It should be appreciated that the computer, processor, microprocessor controller, or programmable hardware may include a storage component (e.g., RAM, ROM, flash memory, etc.) that can store or receive software or computer code that implements the task execution methods described herein when said software or computer code is accessed by the computer, processor, or hardware and executed. Furthermore, when a general purpose computer accesses code for implementing the task execution method illustrated herein, execution of the code converts the general purpose computer to a specialized computer for executing the task execution method illustrated herein.

A person of ordinary skill in the art may be aware that units and method steps of the examples described in connection with the embodiments disclosed herein may be implemented by electronic hardware or a combination of computer software and electronic hardware. Whether the functions are performed by hardware or software depends on specific applications and design constraint conditions of the technical solutions. A person skilled in the art may use different methods to implement the described functions for each specific application, but it should not be considered that the implementation goes beyond the scope of the embodiments of this application.

The foregoing detailed description is merely used to illustrate some embodiments of the present disclosure, and is not intended to limit the embodiments of the present disclosure; various changes and modifications can be made by persons having ordinary skill in the art without departing from the spirit and scope of the embodiments of the present disclosure, and therefore, all equivalent technical solutions fall within the scope of the embodiments of the present disclosure, and the patent protection scope of the embodiments of the present disclosure should be defined by the claims.

1. A task execution method, applied to a client terminal, the method comprising:
detecting an execution trigger code for a preset task during a process of executing a program code by means of a code execution environment;
performing, according to the execution trigger code, a scheduling strategy querying, by means of the code execution environment, to obtain a scheduling strategy for the preset task; and
scheduling, via an environment communication interface of the code execution environment, the preset task to be executed in a code execution environment of a cloud target device indicated by the obtained scheduling strategy.

2. The method of claim 1, wherein the step of scheduling, via the environment communication interface of the code execution environment, the preset task to be executed in the code execution environment in the cloud target device indicated by the obtained scheduling strategy comprises:
obtaining an environment execution code of the preset task by means of the code execution environment, wherein the environment execution code is a code executable in the code execution environment; and
scheduling, via the environment communication interface of the code execution environment, the environment execution code of the preset task to be executed in the code execution environment in the cloud target device indicated by the obtained scheduling strategy.

3. The method of claim 2, wherein the step of scheduling, via the environment communication interface of the code execution environment, the environment execution code of the preset task to be executed in the code execution environment in the cloud target device indicated by the obtained scheduling strategy comprises:
sending, via the environment communication interface of the code execution environment, environment parameter of the code execution environment of the client terminal and the environment execution code of the preset task to the environment communication interface of the code execution environment in the cloud target device indicated by the obtained scheduling strategy, so that the cloud target device initializes the code execution environment in the cloud target device according to the environment parameter and executes the environment execution code of the preset task upon completion of initialization.

4. The method of claim 2, wherein the step of performing, according to the execution trigger code, the scheduling strategy querying, by means of the code execution environment to obtain the scheduling strategy for the preset task comprises:
sending a scheduling strategy query request for the preset task to at least one of an edge cloud and a center cloud, according to the execution trigger code and by means of the code execution environment; and receiving a query result in response to the scheduling strategy query request and obtaining the scheduling strategy for the preset task according to the query result;
or alternatively,
performing a client-side local scheduling strategy querying, according to the execution trigger code and by means of the code execution environment, and obtaining the scheduling strategy for the preset task.

5. The method of claim 1, wherein before the step of detecting the execution trigger code for the preset task during the process of executing the program code by means of the code execution environment, the method further comprises:
receiving a system call instruction containing a call of the preset task; and
creating the code execution environment for a program corresponding to the system call instruction, so that the preset task is executed in the code execution environment.

6. The method of claim 1, wherein the code execution environment is a WebAssembly standard-based code execution environment.

7. A task execution method, applied to a cloud, the method comprising:
receiving, via an environment communication interface of a code execution environment, a scheduling strategy query request sent from a code security environment of a client terminal for a preset task;
obtaining operation state information of the cloud in response to the scheduling strategy query request;
determining a target device of the cloud that is capable of executing the preset task according to the operation state information, and determining a scheduling strategy according to the target device; and
sending the scheduling strategy to a code execution environment in the client terminal via the environment communication interface of the code execution environment in the cloud.

8. The method of claim 8, wherein the method further comprises:
receiving, via a environment communication interface of a code execution environment in the target device, an environment parameter of the code execution environment in the client terminal sent by the client terminal and an environment execution code of the preset task, wherein the environment execution code is a code executable in the code execution environment; and
initializing the code execution environment in the target device according to the environment parameter, and executing the environment execution code of the preset task upon completion of the initialization.

9. The method of claim 8, wherein the method further comprises:
if it is determined that the target device capable of executing the preset task does not exist in the cloud according to the operation state information, returning task rejection information to the code execution environment in the client terminal, via the environment communication interface of the code execution environment in the cloud, so that the client terminal executes the preset task in the code execution environment in the client terminal.

10. The method of claim 8, wherein the code execution environment is a WebAssembly standard-based code execution environment.

11. A task execution system, comprising at least a client terminal and a cloud, wherein:
the client terminal is configured to detect an execution trigger code for a preset task during a process of executing a program code by means of a code execution environment; perform, according to the execution trigger code, a scheduling strategy querying, by means of the code execution environment, to obtain a scheduling strategy for the preset task; and schedule, via an environment communication interface of the code execution environment, the preset task to be executed in the code execution environment of a cloud target device indicated by the obtained scheduling strategy; and
the cloud is configured to receive, via an environment communication interface of a code execution environment in the cloud, a scheduling strategy query request sent from the client terminal for the preset task; determine and return a scheduling strategy to the code execution environment in the client terminal in response to the scheduling strategy query request; and execute the preset task scheduled by the client terminal, by means of the code execution environment in the cloud target device indicated by the scheduling strategy.

12. The system of claim 12, wherein:
the client terminal is configured to obtain an environment execution code of the preset task by means of the code execution environment in the client terminal, wherein the environment execution code is a code executable in the code execution environment; and send the environment execution code of the preset task to the code execution environment in the cloud target device for execution via the environment communication interface of the code execution environment.

13. The system of claim 12, wherein the code execution environment is a WebAssembly standard-based code execution environment.

14. (canceled)

15. The method of claim 1, wherein the step of performing, according to the execution trigger code, the scheduling strategy querying, by means of the code execution environment to obtain the scheduling strategy for the preset task comprises:
sending a scheduling strategy query request for the preset task to at least one of an edge cloud and a center cloud, according to the execution trigger code and by means of the code execution environment; and receiving a query result in response to the scheduling strategy query request and obtaining the scheduling strategy for the preset task according to the query result;
or alternatively,
performing a client-side local scheduling strategy querying, according to the execution trigger code and by means of the code execution environment, and obtaining the scheduling strategy for the preset task.

16. The system of claim 11, wherein the code execution environment is a WebAssembly standard-based code execution environment.
